(19) United States
(12) Patent Application Publication
(10) Pub. No.: US 2004/0001468 A1
(43) Pub. Date: Jan. 1, 2004

(54) Technique for interworking a wlan with a wireless telephony network

(76) Inventors: Guillaume Bichot, Princeton, NJ (US); Jun Li, Plainsboro, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/186,022

(22) Filed: Jun. 28, 2002

(51) Int. Cl. H04Q 7/24

(52) U.S. Cl. 370/338; 370/349

(57) ABSTRACT

Interworking of a wireless telephony network (12) with a wireless Local Area Network (10) serving at least one mobile terminal user (14) is accomplished by reserving a General Packet Radio Service (GPRS) communications channel (20) of the wireless telephony network. Control communications signals received in the WLAN (10) from the mobile terminal user are communicated across the GPRS channel (20) to the wireless telephone network (12) and likewise, control communications signals from the wireless telephony network pass to the WLAN over the channel. Using the GPRS channel to carry control communications signals between the WLAN (10) and the WLAN (12) affords the advantage of a loose coupling without the risk of sending sensitive control information over a non-secure link.

### TECHNICAL FIELD

This invention relates to a technique for interworking a wireless Local Area Network (WLAN) with a wireless telephony network to enable sharing of control paradigms, such as those associated with Authentication, Authorization and Accounting.

### BACKGROUND ART

Advances in the field of WLAN technology has led to the availability of relatively inexpensive WLAN equipment, which, in turn, has resulted in the availability of publicly accessible WLANs at rest stops, cafes, libraries and similar public facilities. Presently, WLANs offer users the opportunity to access either a private data network, such as a Corporate Intranet, or a public data network such as the Internet. Few if any publicly accessible WLANs offer any type of telephone service, let alone, wireless telephony service.

Presently, those desirous of obtaining wireless telephony service typically subscribe to one of the many providers of such service. Today's wireless telephony service providers not only offer voice-calling capability, but also offer General Packet Radio Service (GPRS), thereby affording subscribers the capability of exchanging data packets via a mobile terminal. While GPRS exists in many areas, data transmission rates typically do not exceed 56 Kbs and the costs incurred by wireless network service providers to support this service remain high, making GPRS expensive.

The relatively low cost to implement and operate a WLAN, as well as the available high bandwidth (usually in excess of 10 Megabits/second) makes the WLAN an ideal access mechanism through which a mobile wireless terminal user can exchange packets with a wireless telephony network. Unfortunately, present-day techniques for interworking (i.e., coupling) WLANs and wireless telephony networks incur difficulties. For example, an interworking technique, known as “loose coupling,” proposes the use of an IP link through the Internet to carry control information between the WLAN and the wireless telephony network. This solution incurs the disadvantage that sensitive validation (authentication) information remains vulnerable to potential interception upon transmission through the Internet.

To avoid the risk of potential interception of sensitive data, another interworking solution, known as “tight coupling,” proposes to use of a leased private communication line to carry both data and control information between a gateway in the WLAN (typically referred to as an Interworking Unit or IWU) and the wireless telephony network. Employing a leased private line virtually eliminates the possibility of interception at the expense of a monthly line rental that greatly increases operating costs.

Further, such tight coupling incurs the disadvantage that the IWU in the WLAN has to mimic the wireless network protocol (e.g., the 3GPP protocol for wireless telephony networks that have adopted the 3GPP standard). Under such circumstances, the IWU must mimic the 3GPP protocol in order to appear as a component of the 3GPP wireless telephony network; therefore giving rise to much complexity that is undesirable. For that reason, loose coupling is preferred.

Thus, there is need for technique for interworking a wireless telephony network and a WLAN that overcomes these disadvantages.

### BRIEF SUMMARY OF THE INVENTION

Briefly, in accordance with the present principles, a method is provided for interworking a WLAN and a wireless telephony network that provides for more secure exchange of authentication information but without the associated cost of a leased line. To provide for such interworking, a wireless telephony channel is established between the wireless telephony network and the WLAN. In practice, one of the wireless channels ordinarily available for communication with a mobile terminal is reserved for communicating information, and particularly control information between the WLAN and the wireless telephony network. To the extent that the WLAN serves multiple mobile terminal users, the signals from such mobile terminal users are multiplexed to yield a communication stream transmitted across the wireless channel to the wireless telephony network.

Using one of the wireless telephony network communications channels to carry control information, and more particularly, authentication information, between the WLAN and the wireless telephony network affords increased security, as compared to sending such information over the Internet while avoiding the expense of a leased line. Typically, wireless telephony networks embody a security protocol associated with communication of authentication information across the radio channels directly between a mobile terminal user and the wireless telephony network. In the course of gaining direct access to a wireless telephony network, a mobile terminal user must exchange sensitive authentication data with the wireless telephony network. Thus, using an existing GPRS radio channel to carry control information between the WLAN and the wireless telephony network enables the use of interfaces and authentication protocols that already exist in the wireless telephony network.

### BRIEF DESCRIPTION OF THE DRAWINGS

FIG. 1 depicts a block schematic diagram of a WLAN interworked with a wireless telephony network in accordance with the present principles;

FIG. 2 depicts the protocol stacks of the network elements in the WLAN and wireless telephony network of FIG. 1 associated with the use the Authentication, Authorization and Accounting (AAA) protocol;

FIG. 3 depicts the protocol stacks of the network elements in the WLAN and wireless telephony network of FIG. 1 associated with the use of the RADIUS protocol; and

FIG. 4 depicts the protocol stacks of the network elements in the WLAN and wireless telephony network of FIG. 1 associated with the use of the GMM-like protocol.

### DETAILED DESCRIPTION

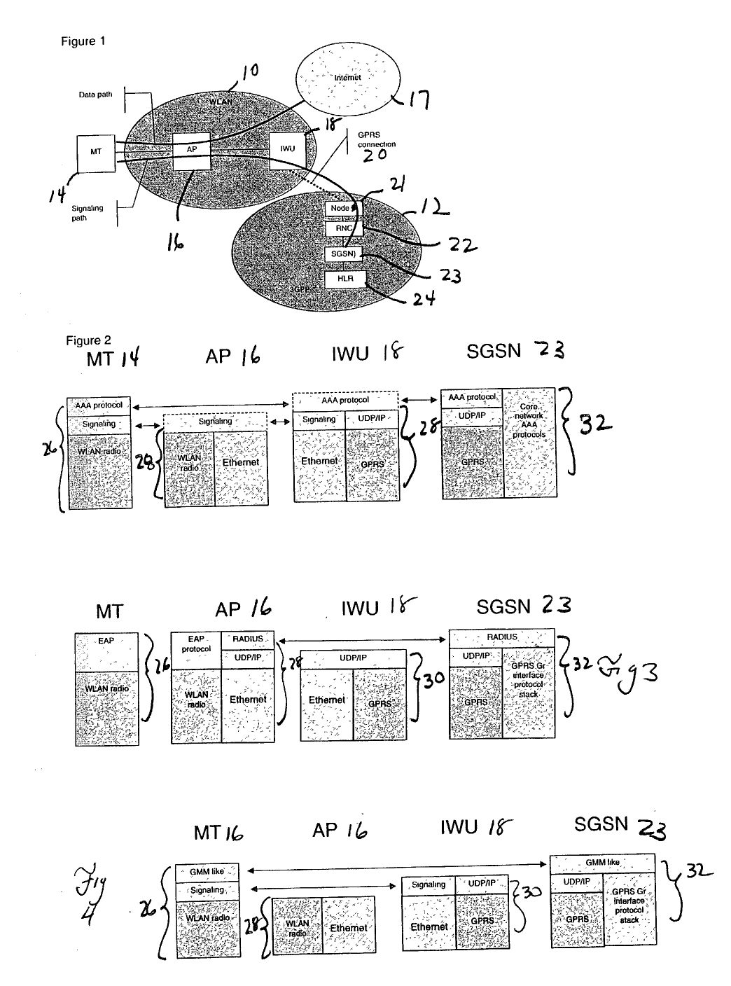

FIG. 1 depicts the combination of a Wireless Local Area Network (WLAN) 10 interworked with a wireless telephony network 12 in accordance with present principles. As discussed in greater detail below, the interworking of the WLAN 10 with the wireless telephony network 12 allows a user, represented by mobile terminal (MT) 14, to gain access to the mobile telephony network to receive General Packet Radio Service (GPRS) through the WLAN 10. In its simplest form, the WLAN 10 includes at least one access point (AP) 16 embodied within which is a radio frequency (RF) transceiver (not shown) for exchanging information with a RF transceiver (not shown) in the MT 14. In practice, the RF transceivers in the MT 14 and AP 16 utilize a well-known wireless communications protocol such as the “Bluetooth” or IEEE 802.11 protocol. In this way, the MT 14, once in radio communication range with the AP 16 in the WLAN 10, can easily commence a communications session with the AP 16 without concern about the details of the protocol wireless communications protocol. In practice, the AP 16 has a data connection to a data network 17 illustratively illustrated as the Internet, for communicating data between the MT 14 and the wireless telephony network 10.

Within the WLAN 10, an interworking unit (IWU) 18 establishes a linkage with the mobile telephony network 12 to permit the MT 14 to send control information to, and receive control information from the telephony network to enable the MT 14 to gain access thereto. Such control information will include authentication information. In accordance with present principles, the IWU 18 establishes a linkage with the wireless telephony network 12 by reserving a GPRS radio channel 20 of the kind otherwise used by mobile terminal users (not shown) to communicate directly with the wireless telephony network through a Node 21 served by a radio network controller (RNC) 22.

Although illustrated in FIG. 1 as a stand-alone device, the IWU 18 can exist as part of the AP 16. To accommodate the possibility that the WLAN 10 could have multiple mobile terminals in communication therewith at the same time, the IWU 18 includes a multiplexer (not shown) for multiplexing communications signals from each of the MTs, such as MT 14, into a combined communications stream for transmission to the wireless telephony network 12. By the same token, the IWU 18 also includes a de-multiplexer (not shown) for de-multiplexing a combined signal stream received from the wireless telephony network 12 into constituent signals for distribution to corresponding MTs in communication with the WLAN 10. The multiplexing of signals from several MTs could be realized through the usage of a transport protocol, such as by allocating a User Datagram Protocol (UDP) (not shown) in the wireless telephony network 12, or could be achieved simply by using an authentication protocol, such as the well-known Authentication, Authorization and Accounting (AAA) protocol discussed hereinafter.

In practice, the wireless telephony network 12 conforms to one of the 2.5 G or 3G Standards for Mobile Wireless Telephony Networks as known to those skilled in the art. In accordance with such standards, the wireless telephony network 12 includes a Serving GPRS Service Node (SGSN) 23 that exchanges information with RNC 23 in communicates with the IWU 18 of the WLAN 10 through the port 21. Typically, the wireless telephony network 12 can include a plurality of SGSNs but only a single SGSN 23 appears in FIG. 1 for purposes of simplicity.

In practice, each SGSN, such as SGSN 23, acts as a control hub for the wireless telephony network 12. To that end, each SGSN has the necessary infrastructure (interfaces) and logic (communications protocols) to manage not only a plurality of mobile terminals (not shown) in direct contact with the wireless telephony network 12, but also to manage each MT, such as MT 14, in communication with the wireless telephony network 12 through the WLAN 10. Associated with the SGSNs in the wireless telephony network 12, such as SGSN 23, is a home location register (HLR) 24 that includes a database (not shown) for storing information about each MT, including each MT (e.g., MT 14) that accesses the wireless telephony network 12 through the WLAN 10.

As indicated, each SGSN, such as SGSN 23, includes the necessary interfaces and protocols to support the exchange of control information with one or more mobile terminal users (not shown) in direct communication with the wireless telephony network 12. Thus, each SGSN, such as the SGSN 23, has the capability of handling control information transmitted across GPRS channel, such as channel 20. Therefore, utilizing the GPRS channel 20 to carry control information between the WLAN 10 and the wireless telephony network 12 does not require the addition of new interfaces or new protocols.

In practice, interworking of the WLAN 10 and the wireless network 12 relies on different protocols for communication of different types of control information. FIG. 2 depicts the protocol stacks for the MT 14, AP 16, IWU 18 and SGSN 23 associated with the use of the AAA protocol as the top level protocol for communicating authentication, authentication and accounting information. As seen in FIG. 2, the MT 14 has a protocol stack 26 at the top of which resides the AAA protocol. Beneath the AAA protocol resides a signaling protocol via which the MT 14 exchanges signaling information with the AP 16 and/or the IWU 18. Beneath the signaling protocol in the stack 26 of the MT 14 resides a WLAN radio protocol, which the MT 14 utilizes to undertake RF communications with the WLAN 10.

The AP 16 has a protocol stack 28 at the top of which typically resides the signaling protocol for enable the exchange of signaling information with the MT 14. Beneath the signaling protocol in the stack 28 resides the WLAN radio protocol for facilitating RF communication with the MT 14. The protocol stack 28 of the AP 16 also carries an Ethernet communications protocol at the same level as the WLAN radio protocol to enable the AP 16 to exchange Ethernet communications with the IWU 18. In the illustrated embodiment of FIG. 1 wherein the AP 16 and the IWU 18 exist as separate entities, the protocol stack 28 within AP 16 does not contain the AAA protocol because there is no need for AP 16 itself to perform any operation on the AAA information from MT 14, other than to pass such information to the IWU 18.

The IWU 18 has a protocol stack 30 at the top of which resides the AAA protocol to enable the IWU 18 to negotiate authorization and authentication of the MT 14 with the SGSN 23 in the wireless telephony network 12. Immediately beneath the AAA protocol in the stack 30 resides a user plane that includes the signaling protocol and the UDP/IP (User Datagram Protocol/Internet Protocol), the latter being used for formatting messages for exchange with the wireless telephony network 12. At the next lower layer (the control plane), the protocol stack 30 carries Ethernet protocol and the GPRS protocol. The GPRS protocol enables the IWU 18 to interface with the wireless telephony network 12.

The SGSN 23 has a protocol stack 32 whose upper-most layer carries the AAA protocol. The protocol stack 32 carries the UDP/IP beneath the AAA protocol. Lying beneath the UDP/IP, the protocol stack 32 carries the GPRS protocol that is distributed among several elements in the wireless telephony network. At the same layer as the AAA protocol, the SGSN protocol stack 32 includes a core network AAA protocol, typically gathered from the other protocols in the stack to enable the SGSN 23 to interact with the wireless telephony network 12 to accomplish authorization, authentication and accounting.

Rather than utilize the AAA protocol as illustrated in FIG. 2 as the top-level protocol for authentication, other protocols can be used. In an alternate preferred embodiment depicted in FIG. 3, the MT 14 protocol stack 26 carries the Equivalent Access (EA) protocol at its top level for handing both authentication and signaling communications. Beneath the EA protocol resides the WLAN radio protocol as described previously. The protocol stack 28 of the AP 16 of FIG. 3 carries the EA protocol at its top level to permit interfacing with the MT 14. Further, the top level of the protocol stack 28 of the AP 16 includes the well-known Remote Authentication Dial-In User Service (RADIUS) protocol, which the AP 16 uses to interact with the SGSN 23. Immediately beneath the RADIUS protocol in the protocol stack 28 of the AP resides the UDP/IP. The WLAN protocol resides beneath the EAP in the protocol stack 28 of the AP 16 for enabling the AP 16 to manage the WLAN radio communications. The Ethernet protocol resides at the same level in the protocol stack 28 as the WLAN protocol for enabling the AP 16 to manage Ethernet communications with the IWU 18.

The IWU 18 of FIG. 3 has a protocol stack 30 that carries the UDP/IP at its top level for handling signaling-type communications between the AP 16 and the SGSN 23. Beneath the UDP/IP in the protocol stack 30 of the IWU 18 resides the Ethernet protocol for enabling the IWU to manage Ethernet communications of packets with the AP 16.

The SGSN 23 of FIG. 3 has a protocol stack 32 at the top of which resides the RADIUS protocol for handling access authentication with the AP 16. Lying beneath the RADIUS protocol in the protocol stack 32 is the UDP/IP protocol. Also lying beneath the RADIUS protocol is a GPRS Interface protocol via which the SGSN 23 manages the GPRS functions in the wireless network 12 of FIG. 1.

FIG. 4 illustrates the use a GMM-like protocol as the top-level protocol for authentication. As seen in FIG. 4, the protocol stack 26 of the MT 14 carries the GMM-like protocol at the top level to enable the MT 14 to pass authentication information to the SGSN 23 with no intervention by the AP 16 or the IWU 18. Lying beneath the GMM-like protocol within the protocol stack 26 of the MT 14 is the signaling protocol to enable the MT to exchange signaling information with the IWU 18. Beneath the signaling protocol in the protocol stack 26 is the WLAN radio protocol as described previously.

The AP 16 has a protocol stack 28 that contains the WLAN radio protocol at its top level for managing the radio communications between the WLAN 10 and the MT 14. The protocol stack 28 of the AP 16 also contains the Ethernet protocol for enabling the AP to communicate with the IWU 18 via Ethernet-formatted signals. Note that protocol stack 28 of the AP 16 of FIG. 4 lacks both the GMM-like protocol and the signaling protocol because in this illustrative embodiment, authentication information from the MT 14 passes to the SGSN 23 without processing by either the AP 16 or the IWU 18.

The IWU protocol stack 30 has the signaling protocol and the UDP/IP at its top level to facilitate the communication of signaling information between the MT 14 and the SGSN 23. Beneath the Signaling and UDP/IP protocols, the IWU protocol stack 30 carries the Ethernet protocol and the GPRS protocols as discussed.

The SGSN protocol stack 32 carries the GMM-like protocol at its upper-most level to facilitate the exchange of authentication information with the MT 14. Below the GMM-like protocol, the SGSN protocol stack 32 contains the UDP/IP and the GPRS protocol as well as the GPRS interface protocol stack.

The foregoing describes a technique for interworking a WLAN with a wireless telephony network to provide a tight coupling therebetween via a GPRS channel so as to obtain security comparable to a leased line connection but without the associated cost.

1. A method for interworking a WLAN network accessed by at least one mobile terminal user, and a wireless telephony network, comprising the steps of:
establishing a wireless telephony communications link between the WLAN and the wireless telephony network;
receiving in the WLAN a first control communications signal from the at least one mobile terminal user and communicating the first control communications signal from the WLAN network to a wireless telephony network across the wireless telecommunications link.

2. The method according to claim 1 wherein the step of establishing the wireless telecommunications link includes the step of reserving a GPRS radio channel between the WLAN and the wireless telephony network.

3. The method according to claim 1 further including the steps of:
communicating a second control communications signal from the wireless telephony network to the WLAN across the wireless telephony communications link between the wireless telephony network and the WLAN; and
distributing the second control communications signal to at least one mobile terminal user in communication with the WLAN.

4. The method according to claim 1 wherein the step of communicating the first control communications signal includes the step of communicating authentication information received in the WLAN from the at least one mobile terminal user in accordance with an Authentication Access and Accounting protocol (AAA).

5. The method according to claim 1 wherein the step of communicating the first control communications signal includes the step of communicating authentication information received in the WLAN from the at least one mobile terminal user in accordance with a Remote Authentication Dial-In User Service (RADIUS) protocol.

6. The method according to claim 1 wherein the step of communicating the first communications signal includes the step of communicating authentication information received in the WLAN from the at least one mobile terminal user in accordance with a General Packet Radio Service Mobile Management (GMM)-like protocol.

7. The method according to claim 1 further including the step of communicating data packets from the at least one mobile terminal user to the WLAN using an Ethernet protocol.

8. A method for interworking a WLAN network accessed by at least one mobile terminal user, and a wireless telephony network, comprising the steps of:
establishing a wireless telephony communications link between the WLAN and the wireless telephony network;
transmitting a first control communications signal from the Wireless telephony network to the WLAN across the wireless telephony communications link; and
distributing the first communications control signal to the least one mobile terminal user in communication with the WLAN.

9. The method according to claim 9 wherein the step of establishing the wireless telecommunications link includes the step of reserving a GPRS radio channel between the WLAN and the wireless telephony network.

10. The method according to claim 7 further including the steps of:
transmitting a second control communications signal from at the least one mobile terminal user into the WLAN; and
communicating the second communications signal from the WLAN network to wireless telephony network across the wireless telecommunications link.

11. The method according to claim 9 wherein the step of communicating the first control communications signal includes the step of communicating authentication information to the at least one mobile terminal user in accordance with an Authentication Access and Accounting protocol (AAA).

12. The method according to claim 9 wherein the step of communicating the first control communications signal includes the step of communicating authentication information to the at least one mobile terminal user in accordance with a Remote Authentication Dial-In User Service (RADIUS) protocol.

13. The method according to claim 9 wherein the step of communicating the first control communications signal includes the step of communicating authentication information to the at least one mobile terminal user in accordance with a General Packet Radio Service Mobile Management (GMM)-like protocol.

14 The method according to claim 9 further including the step of communicating data packets to the at least one mobile terminal user from the WLAN using an Ethernet protocol.

15. A method for interworking a WLAN network accessed by a plurality of wireless terminals, and a wireless telephony network, comprising the steps of:
establishing a wireless telephony communications link between the WLAN and the wireless telephony network;
multiplexing first control communications signals received from the plurality of mobile terminal users into a first combined signal stream;
communicating the first combined signal stream from the WLAN network to a wireless telephony network across the wireless telecommunications link;
transmitting a second combined communications signal stream of multiplexed control communications signals from the wireless telephony network to the WLAN across the wireless telephony communications link;
de-multiplexing the second combined signal stream into constituent control signals; and
distributing the constituent signals to corresponding mobile terminals users in communication with the WLAN.

16. A communications system, comprising:
a wireless Local Area Network (LAN) accessible by at least one mobile terminal user;
a wireless telephony network for providing wireless telephony service; and
a General Packet Radio Service (GPRS) wireless communications channel for carrying control communications signals between the WLAN and the wireless telephony network.

17. The communications system according to claim 15 wherein the control communications signals carried by the General Packet Radio Service (GPRS) wireless communications channel include authentication information formatted in accordance with one of (a) an Authentication Access and Accounting protocol (AAA), (b) a Remote Authentication Dial-In User Service (RADIUS) protocol, and (c) a General Packet Radio Service Mobile Management (GMM)-like protocol.
